(19) United States
(12) Patent Application Publication
(10) Pub. No.: US 2006/0235697 A1
(43) Pub. Date: Oct. 19, 2006

(54) ON-LINE SECURITY MANAGEMENT SYSTEM

(75) Inventor: Michael W. FILIBECK, Long Beach, CA (US)

Correspondence Address: NOVAK DRUCE & QUIGG, LLP, 1300 EYE STREET NW, 400 EAST TOWER, WASHINGTON, DC, 20005, US

(73) Assignee: AMERICAN RESEARCH & TECHNOLOGY, Century City, CA (US)

(21) Appl. No.: 10/907,739

(22) Filed: Apr. 14, 2005

(51) Int. Cl. H04H 9/00; G10L 11/00; H04N 7/16; G10L 21/00

(52) U.S. Cl. 704/273; 725/12

(57) ABSTRACT

The Internet provides communication between a server and security officers, supervisors, client representatives, and a security system computer at a client site. On-line access to the server provides integration and management of security system functions such as maintenance of call lists and reports, shift management, and supervision of security officers. The use of the Internet for communication between the server and the client site computer not only provides faster and more reliable communication but also enables the client site computer to request the server to schedule a contingent future event including a need to service a call list unless the client site computer reports a condition warranting the removal of the contingent event from the schedule. For example, the failure of a security officer to visit a check point at a scheduled time results in the server accessing a call list to notify a designated recipient.

### LIMITED COPYRIGHT WAIVER

A portion of the disclosure of this patent document contains computer display formats to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever.

### FIELD OF THE INVENTION

The present invention relates generally to security management, and more particularly to computerized security systems.

### BACKGROUND OF THE INVENTION

Computerized security systems are often used for protection of homes, commercial property, and industrial sites. A typical computerized security system includes a micro-computer installed at the location to be protected. The micro-computer is programmed to monitor various sensors such as switches on exterior doors and windows, glass breakage sensors, smoke and fire sensors, water level sensors, and panic alarms carried by occupants of the site to be protected. The micro-computer also has a telephone modem to dial-up a connection to a computer at a monitoring station, and also to answer status inquiry calls from the computer at the monitoring station. The micro-computer is programmed to signal a local alarm and also to report an alarm condition to the monitoring station in response to sensor signals indicating a fire or break in.

### SUMMARY OF THE INVENTION

In accordance with one aspect, the invention provides a security management system including a server on the Internet. The server is programmed for maintaining a database including a call list for a site in response to user access over the Internet, and the server is programmed for accessing the call list in order to send a notification of an abnormal condition at the site to a recipient on the call list.

In accordance with another aspect, the invention provides a security management system including a server on the Internet. The server is programmed for maintaining data about security officers, supervisors of the security officers, and clients having sites to be monitored. The server is also programmed for access by operation of an Internet browser program by the security officers, supervisors of the security officers, and representatives of the clients The server is further programmed for setting up respective call lists of recipients and methods for notifying the recipients of abnormal conditions at the sites, and for scheduling security officer shifts at the respective sites, managing use of keys at the respective sites, and managing access of visitors to the respective sites.

In accordance with yet another aspect, the invention provides a method of managing security at a site. The site includes a security system computer linked via the Internet to a server. The server is accessible over the Internet by a user operating an Internet browser program. The method includes the user accessing the server using the Internet browser program to set up a call list for the site, the security system computer sending messages over the Internet to the server to report normal conditions at the site to the server at scheduled times, and upon failing to receive a message reporting a normal condition at the site at a scheduled time, the server accessing the call list in order to send a notification to a recipient on the call list.

In accordance with yet another aspect, the invention provides a computer-implemented method of managing security at a site. The method includes scheduling a security officer to visit check points at the site, setting up a call list including at least one recipient to be notified in the event of the security officer failing to visit at least one of the check points at a scheduled time; and upon detecting a failure of the security officer to visit the check point at the scheduled time, accessing the call list to notify the recipient.

In accordance with a final aspect, the invention provides a computer-implemented method of managing security at a site. The method includes scheduling a security officer to visit the site, setting up a call list including at least one recipient to be notified upon detecting a failure of the security officer to follow a designated path at the site, and upon detecting a failure of the security officer to follow the designated path at the site, accessing the call list to notify the recipient.

### BRIEF DESCRIPTION OF THE DRAWINGS

Additional features and advantages of the invention will be described below with reference to the drawings, in which:

FIG. 1 is a block diagram of an on-line security management system in accordance with the present invention;

FIG. 2 is a block diagram showing details of a client site in the on-line security management system of FIG. 1;

FIG. 3 is a flow chart of a basic condition sensing and reporting procedure executed by a computer at the client site;

FIG. 4 is a flow chart of a procedure executed by an on-line security management server in the system of FIG. 1 for responding to a failure of a security officer to visit a check point at the client site;

FIG. 5 shows various data structures in the on-line security management server for management of scheduled events;

FIG. 6 is a flow chart of a basic procedure executed by the on-line security management server for management of scheduled events;

FIG. 7 is a block diagram of various databases and programs in memory of the on-line server for security management;

FIG. 8 shows a main menu screen of a graphical user interface for Internet access of an administrative user to the on-line server;

FIG. 9 shows the graphical user interface presenting a list of sub-menu items to the administrator in response to the administrator's selection of the “User Management” main menu item;

FIG. 10 shows the graphical user interface responding to the administrator's selection of the “Manage User” sub-menu item;

FIG. 111 shows the main and sub-menu items presented by the graphical user interface to an administrator;

FIG. 12 shows the main and sub-menu items typically presented by the graphical user interface to a supervisor;

FIG. 13 shows the main and sub-menu items typically presented by the graphical user interface to a security officer;

FIG. 14 shows the main and sub-menu items typically presented by the graphical user interface to a client user;

FIG. 15 shows a form used by the graphical user interface for input of information about a user;

FIG. 16 shows a form used by the graphical user interface for assignment of a supervisor to a site;

FIGS. 17 and 18 show a form used by the graphical user interface for assignment of rights to a supervisor;

FIG. 19 shows a form used by the graphical user interface for adding or editing a client call list;

FIG. 20 shows a form used by the graphical user interface for adding or editing a service call list;

FIG. 21 shows a form used by the graphical user interface for adding or editing a specification for a key;

FIG. 22 shows a form used by the graphical user interface for editing a specification for a ring of keys;

FIG. 23 shows a form used by the graphical user interface for authorizing issuance of a key to an employee;

FIG. 24 shows a form used by the graphical user interface for adding shift slots;

FIG. 25 shows a form used by the graphical user interface for assigning a shift to a user;

FIG. 26 shows a form used by the graphical user interface for displaying user details;

FIG. 27 shows a form used by the graphical user interface for displaying a site schedule;

FIG. 28 shows a form used by the graphical user interface for creating or editing identifiers for a vehicle;

FIG. 29 shows a form used by the graphical user interface for creating or editing identifiers for an action taken;

FIG. 30 shows a form used by the graphical user interface for adding or editing a training type;

FIG. 31 shows a form used by the graphical user interface for viewing a log report;

FIG. 32 shows a form used by the graphical user interface for viewing or printing a visitor report;

FIG. 33 shows a print-out of various kinds of reports;

FIG. 34 shows a form used by the graphical user interface for sending a message;

FIG. 35 shows a form used by the graphical user interface for showing a list of messages;

FIG. 36 shows a form used by the graphical user interface for showing a received message;

FIG. 37 shows a form used by the graphical user interface for showing a system setting;

FIG. 38 is a flowchart showing escalation in connection with a call list;

FIG. 39 shows a security officer's Internet capable cell phone being used as a client site computer in connection with an RF-ID tag reader and RF-ID tags that specify respective check points; and

FIG. 40 is a flowchart of basic programming of the Internet capable cell phone in FIG. 39; and

FIG. 41 is a flowchart of more complex programming that could be used for a cell phone that is not Internet capable at the client site of FIG. 39.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DETAILED DESCRIPTION OF THE PREFERRED EMBODIMENT

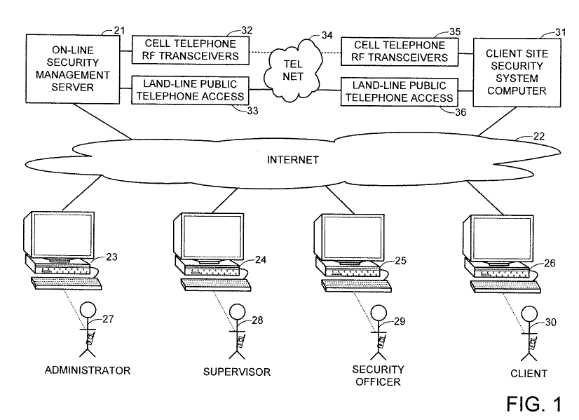

With reference to FIG. 1, there is shown a block diagram of an on-line security management system in accordance with the present invention. The on-line security management system includes a server 21 linked to the Internet for communication via the TCP/IP protocol with a number of user terminals 23, 24, 25, 26. The user terminals access the server 21 using a conventional web browser program such as the Microsoft Internet Explorer (Trademark) program. The user terminals include a terminal 23 for an administrator, a terminal 24 for a supervisor, a terminal 25 for a security officer 29, and a terminal 26 for a client user 30.

In general, the administrator 27 is a person responsible for support and maintenance of software for the on-line security management server 21. The supervisor 28 and the security officer 29 are trained or employed by a company responsible for providing security and guard services. The client user 30 is employed by a company or organization that manages a physical site in need of security services.

The client's physical site includes a client site security system computer 31 that is also liked to the Internet 22 for communication with the on-line server 21 via the Transmission Control Protocol (TCP/IP). For backup in the event of a failure of the Internet connection, the on-line server 31 has conventional dial-up data links to the client site security system computer 31. These conventional dial-up data links include one or more cell phone radio-frequency (RF) transceivers 32 and land-line public telephone access modems 33 at the server site that are linked over the public telephone network 34 to one or more cell phone RF transceivers 35 and land-line telephone access modems 36 at the client site.

The use of the Internet 22 for communication between the on-line security management server 21 and the client site security system computer 31 not only provides faster and more reliable communication but also enables the system to provide new functions and new methods of operation. As will be further described below, the ability of the Internet 22 to maintain a connection between the on-line server 21 and the client site computer 31 enables a method of operation in which the client site computer may request the on-line server to schedule a contingent future event including a need to service a call list unless the client site computer reports a condition warranting the removal of the contingent event from the schedule. Moreover, the ability of the Internet to provide convenient access of the various classes of users to the on-line server 21 permits the integration of virtually all aspects of security system management such as maintenance of call lists and reports, shift management, and supervision and training of security officers.

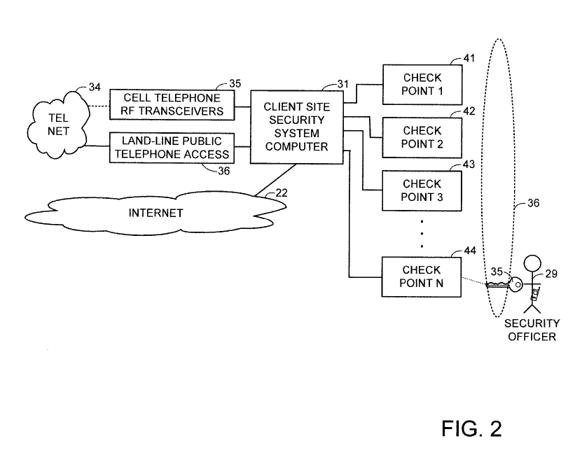

FIG. 2 show details of the client site. Multiple check points 41, 42, 43, 44 are spaced about the client site and linked to the client site system computer. The security officer 29 has a key 35 that can be inserted into a respective key-activated switch at each check point to send a signal to the client site computer 31. In some systems, an electronic badge containing a programmed integrated circuit chip can function in a similar fashion as a key when the badge is placed near a sensor at a check point. In response to the signal, the client site computer 31 makes a record in memory of the particular check point and the time at which the respective key switch was activated. The client site computer also forwards the signal over the Internet 22 to the on-line security management server 21. The security officer 29 walks a pre-assigned path or round 36 in order to visit each of the check points at a respective time in a predetermined sequence.

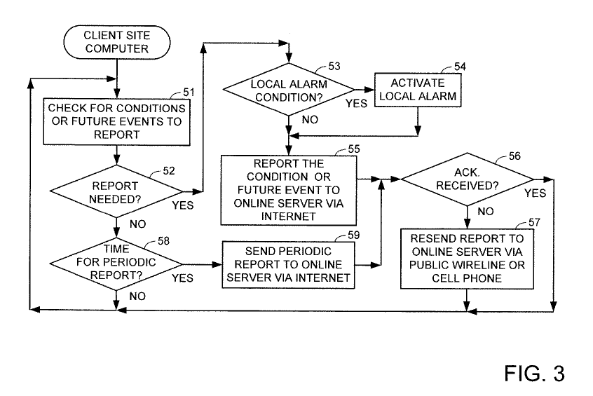

FIG. 3 shows a basic condition sensing and reporting procedure executed by the computer at the client site. In a first step 51, the client site computer checks for conditions or future events to report. The client site computer, for example, checks for sensor signals of abnormal conditions, such as open doors or windows that should be closed, broken glass, and alarm signals from smoke and fire detectors. The client site computer also checks for signals that should normally occur, such as signals from the check points. In step 52, when a report is needed, execution branches to step 53. In step 53, if a signal indicates a local alarm condition, then in step 54, a local alarm is activated, such as a fire alarm in response to an alarm signal from a smoke or fire detector. In step 55, the condition or future event is reported to the on-line server via the Internet. In step 56, if an acknowledgement of the report is not received from the on-line server after a number of re-tries, then in step 57 the report is resent to the on-line server via the public wireline or cell phone modem.

In step 52, if a report is not needed, then execution continues to step 53. In step 53, the client site computer checks whether it is time to send a periodic status report to the on-line computer. In step 59, such a periodic report is sent to the on-line server via the Internet so that the on-line server knows that the client site computer is capable of sending reports of alarm conditions as the need arises.

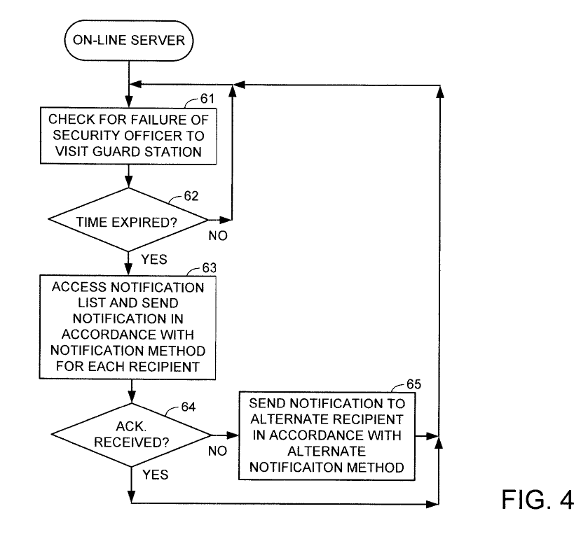

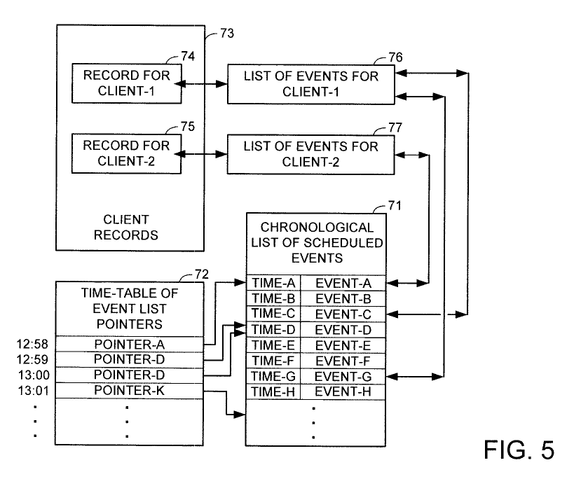

FIG. 4 shows a procedure executed by the on-line security management server for responding to a failure of a security officer to visit a check point at the client site. In a first step 61, the on-line server checks for a failure of a security office to visit a check point. In step 62, if the time for the security officer to visit the check point has expired, then execution continues to step 63. In step 63, the on-line server access a notification list for the particular client site and for the particular condition of interest, and the on-line server sends a notification to each recipient in accordance with a notification method listed for each recipient. For example, the notification list may include, for each listed recipient, a primary notification method such as a land-line or cell telephone number or an E-mail address. In step 64, if the on-line server fails to receive an acknowledgement, such a return sequence of touch tones from a telephone or a return acknowledgement of receipt of the E-mail message, then execution branches to step 65. In step 65, the on-line server sends a notification to an alternate recipient in accordance with an alternate notification method included in the notification list.

It should be apparent that the procedure of FIG. 4 is a specific example of a general technique in which the on-line server schedule a future event that is contingent on a failure to receive a report from a client of the occurrence of a particular condition. Normally the client will send a report of a condition to the on-line server so that the future contingent event should not occur, and the on-line server responds to the report by removing the contingent event from its schedule.

FIG. 5 shows various data structures in the on-line security management server for management of scheduled events. The scheduled events are maintained in a chronological linked-list 71. Each entry in the chronological list 71 identifies the event and a respective time associated with each event. The entries in the chronological list 71 are indexed by respective times, for example, by a time-table 72 of event list pointers. For example, given a particular hour and minute, the time table 72 can be indexed to find a pointer to the next entry in the list that occurs at or after the given hour and minute. Because the on-line server manages security for multiple clients, the scheduled events are also linked to client records 73. A record 74, 75 for each client includes a pointer to a respective list 76, 77 of events for the client. Therefore, given a report from a particular client of a condition for cancellation of an event, the record for the client can be used to find the event to be cancelled.

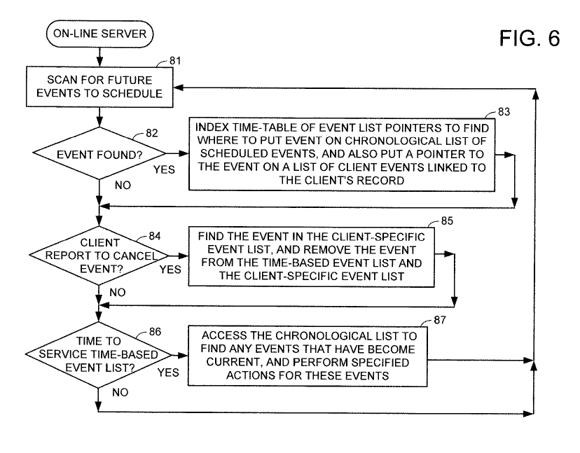

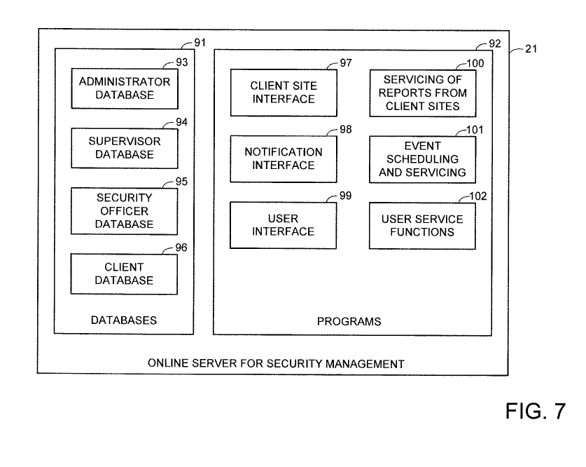

FIG. 6 shows a basic procedure executed by the on-line security management server for management of scheduled events. In a first step 81, the on-line server scans for future events to schedule. For example, in step 81, the on-line server may access a table of the periodic reporting times for the clients, or a queue of requests from the clients for the scheduling of contingent events. In step 82, if an event is found, then execution branches to step 83 to index the time-table of event list pointers to find where to put the event on the chronological list of scheduled events. In step 83, the on-line server also puts a pointer to the event on the list of client events linked to the client's record. Execution continues from step 83 to step 84. Execution also continues from step 82 to step 84 if an event to be scheduled is not found.

In step 84, if the on-line server receives a report of a condition warranting cancellation of a scheduled event, then execution branches to step 85. In step 85, the on-line server finds the event in the client-specific event list, and removes the event from the chronological event list and also from the client-specific event list. Execution continues from step 85 to step 86. Execution also continues from step 84 to step 86 in the absence of a client report to cancel an event.

In step 86, if it is time to service the chronological event list, then execution branches from step 86 to step 87. In step 87, the on-line server accesses the chronological event list to find any events that have become current, and to perform specified actions for these events. After step 87, execution loops back to step 81. Execution also loops back to step 81 from step 86 if it is not yet time to service the chronological event list.

FIG. 7 shows various databases 91 and programs 92 in memory of the on-line server 21. The databases 91 include a database 93 of administrators, a database 94 of supervisors, a database 95 of security officers, and a database 96 of clients. The programs 92 include a client site interface 97 for communicating with a number of client sites, a notification interface 98 for using call lists for notifying users via phone and E-mail about alarm conditions and the occurrence of scheduled events, and a user interface 99 for access to the on-line server 21 via an Internet web browser. The programs 92 further include a program 100 for servicing of reports from client sites, a program 101 for event scheduling and servicing, and a program 102 for user service functions.

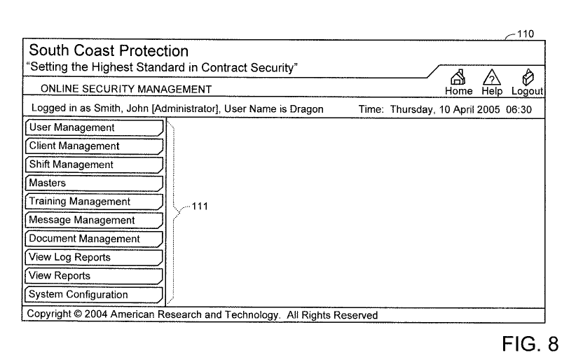

The program 100 determines whether a report signals an alarm condition requiring immediate attention such as alerting the police or fire officials and servicing the client's call list for such alarms, or whether the report requires the scheduling of a future continent event or the cancellation of a scheduled event. The program 101 for event scheduling and servicing is described above generally with respect to FIG. 6 and specifically with respect to the example of FIG. 4. The programs 102 for user service functions collect information for the databases 91 from on-line users and permit the on-line users to view and edit this information in various ways, as further described below with reference to FIGS. 8 to 37.

FIG. 8 shows a main menu screen of a graphical user interface for Internet access of an administrator to the on-line server. The administrator accesses this main menu screen by executing an Internet web browser such as the Microsoft Internet Explorer program, entering a URL of the on-line server, and then entering a username and password. The left-hand side of the main menu screen gives the administrator a list 111 of main menu items including User Management, Client Management, Shift Management, Masters, Training Management, Message Management, Document Management, View Log Reports, View Reports, and System Configuration. In general, each of these main menu items designates a class of service functions for the administrator. By clicking on a main menu item, a list of the service functions in the designated class appears under the selected main menu item. This list of the service functions is presented as a sub-menu.

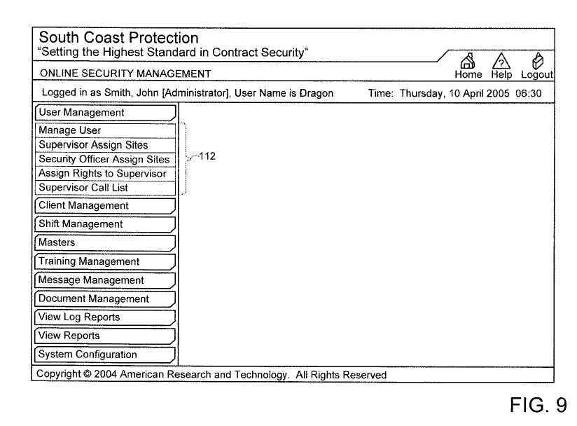

FIG. 9, for example, shows the graphical user interface presenting a list 112 of sub-menu items to the administrator in response to the administrator's selection of the “User Management” main menu item. The list 112 of sub-menu items includes Manage User, Supervisor Assign Sites, Security Officer Assign Sites, Assign Rights to Supervisor, and Supervisor Call List. The administrator can then click on one of the sub-menu items to select a particular on-line service function.

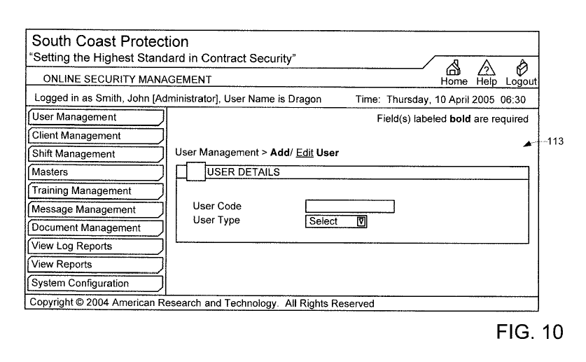

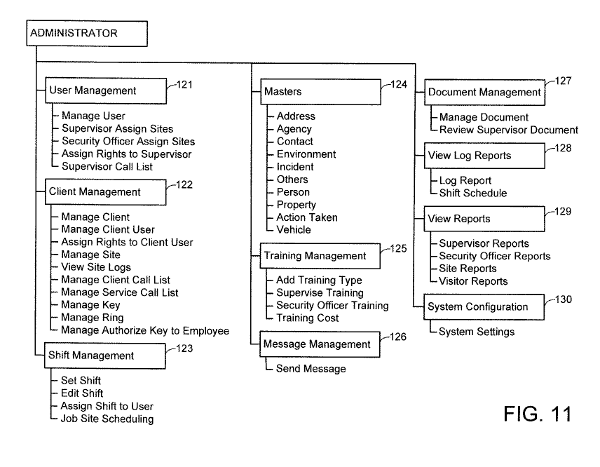

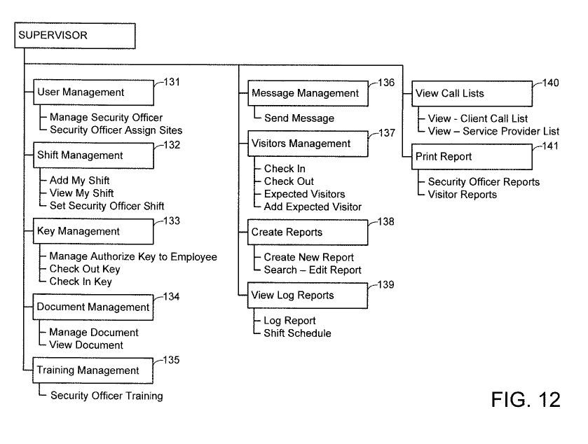

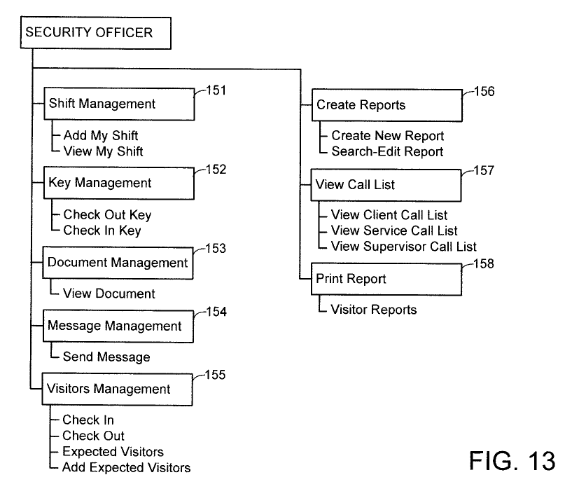

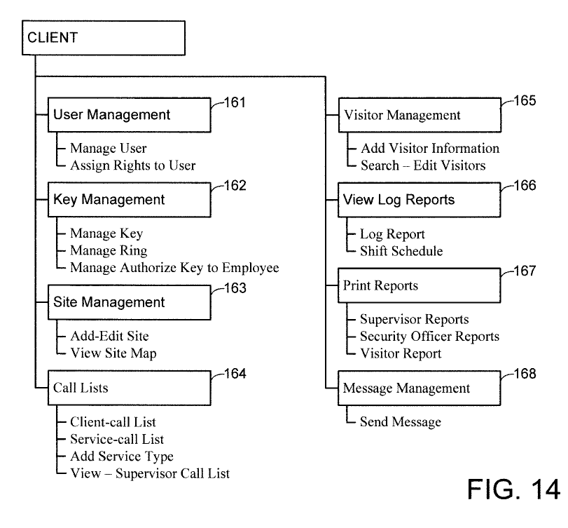

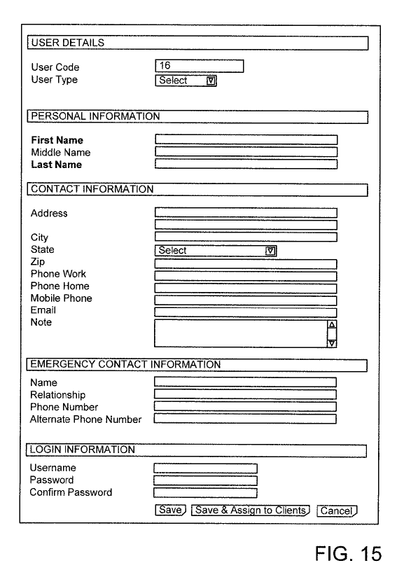

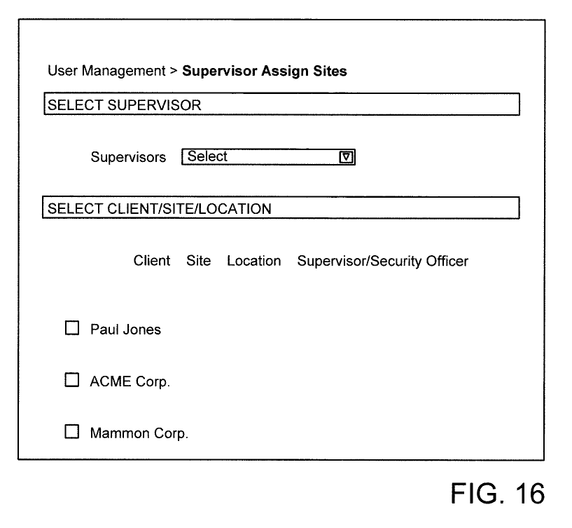

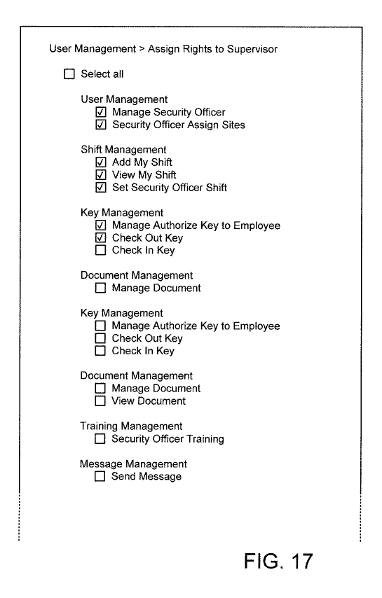

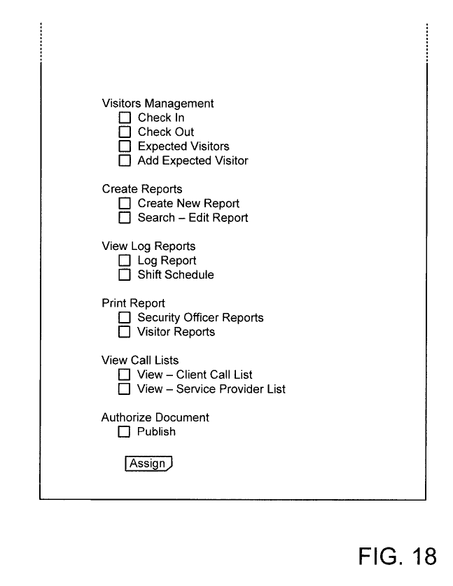

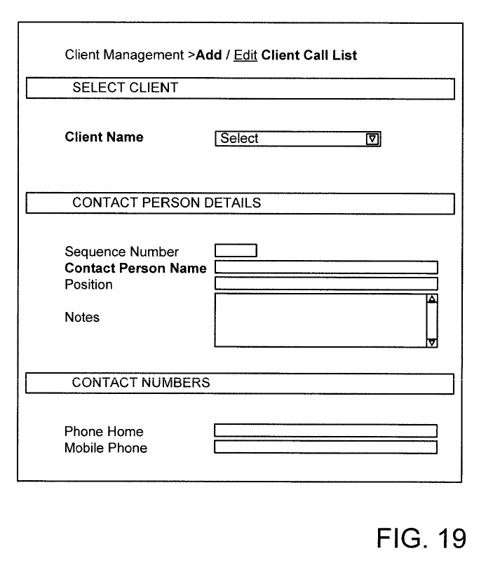

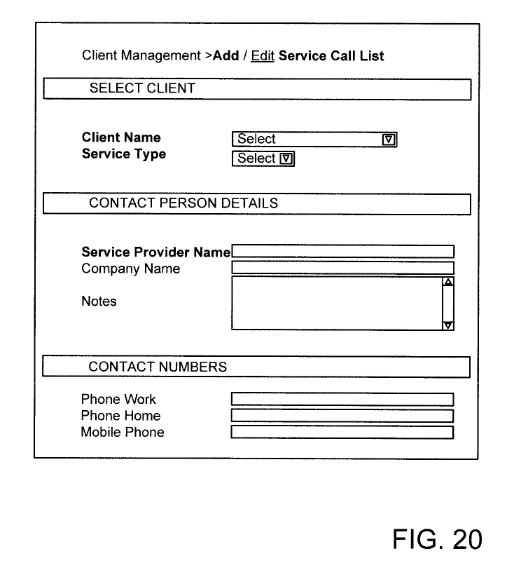

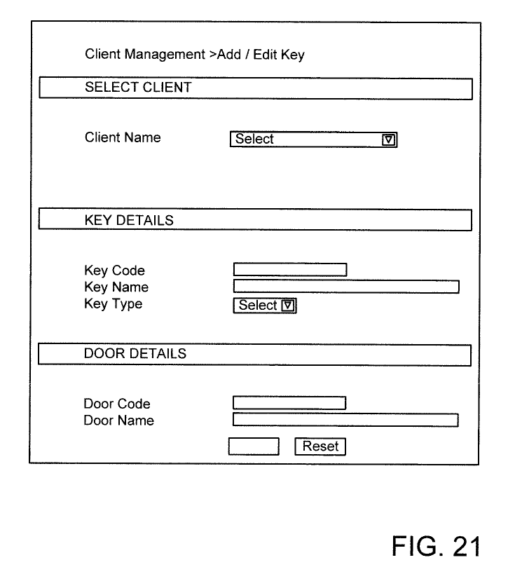

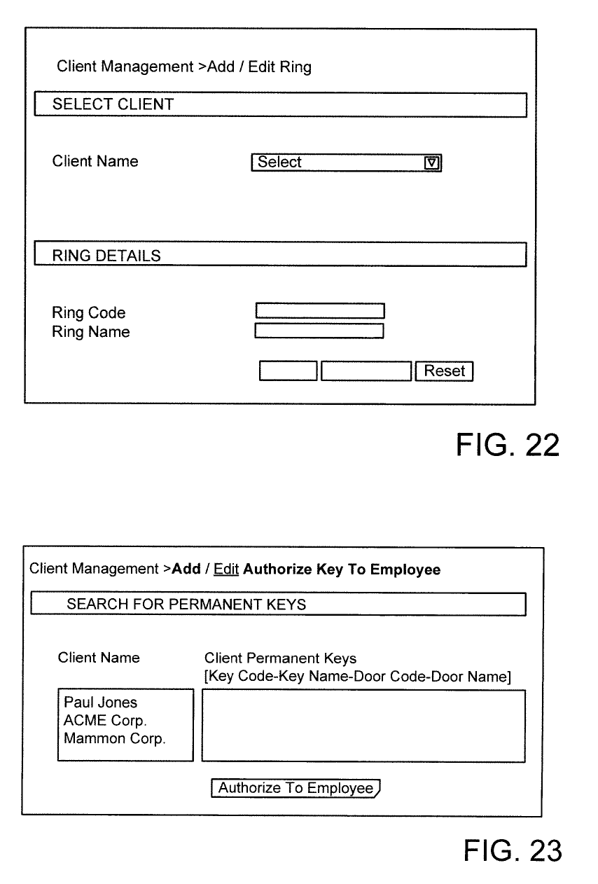

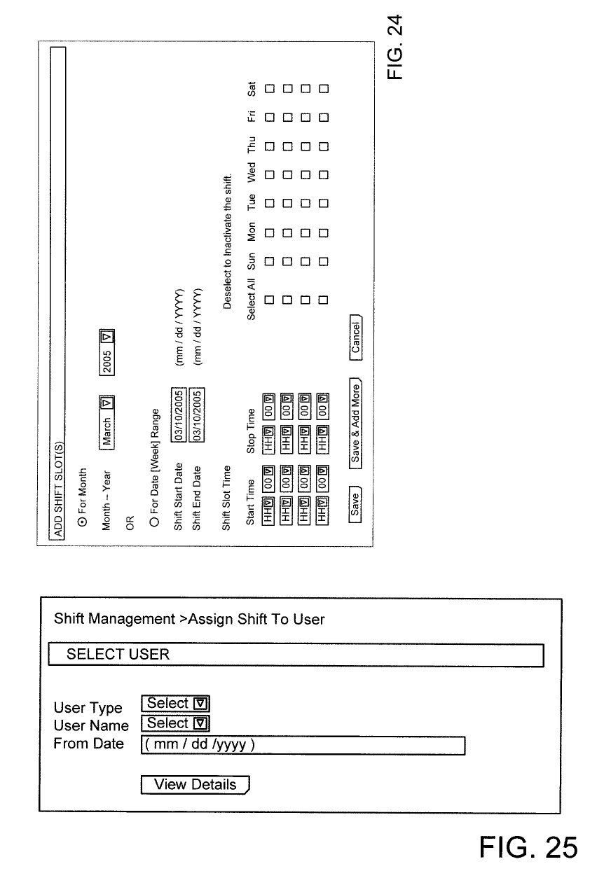

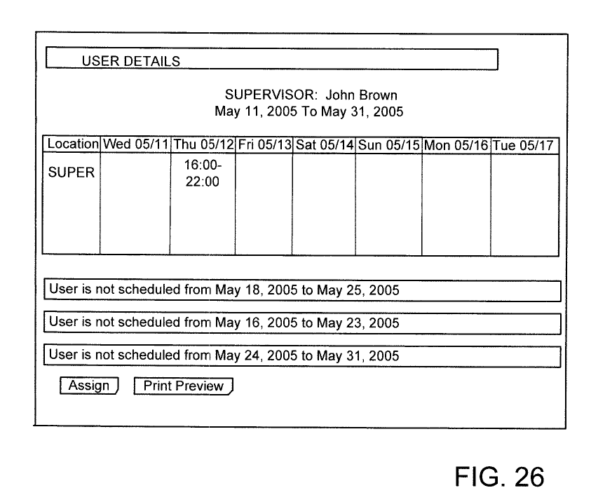

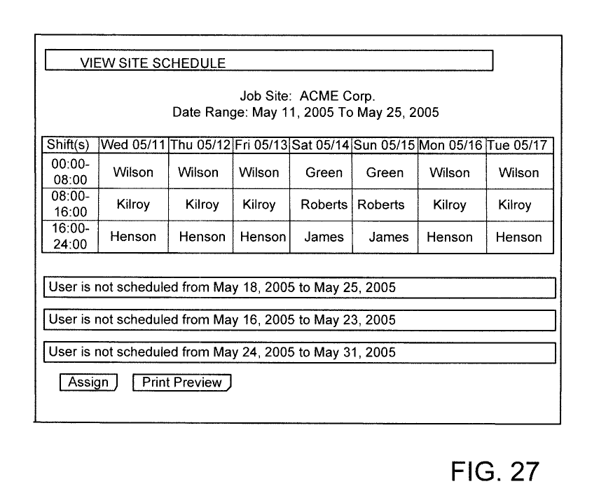

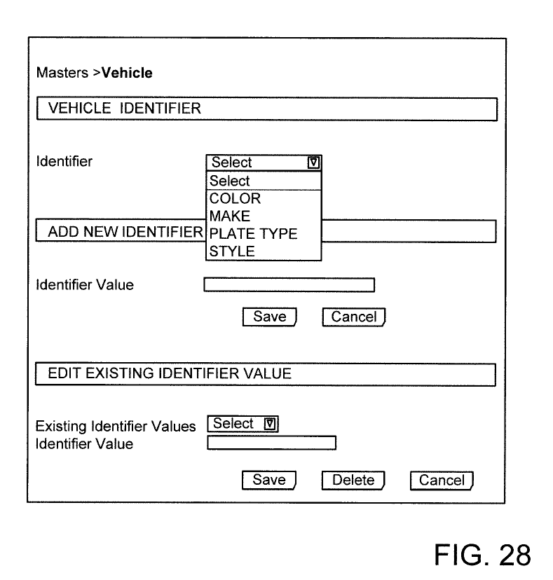

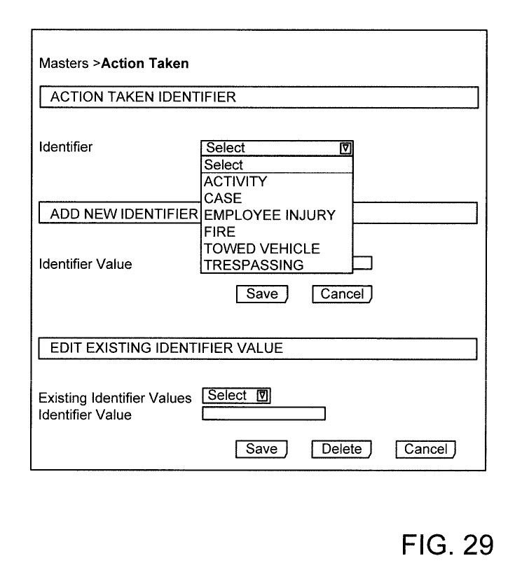

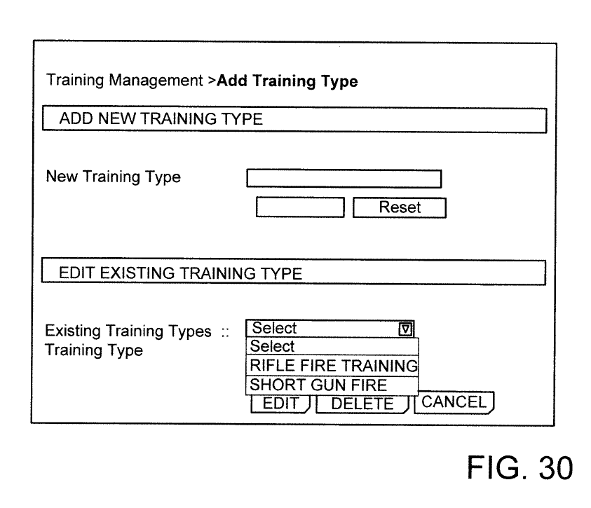

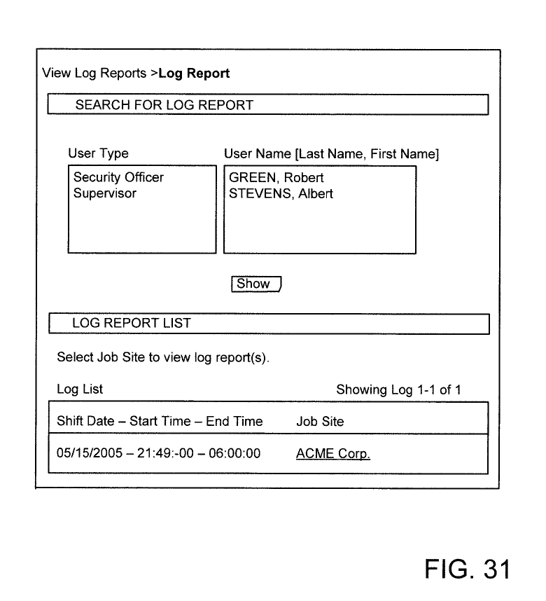

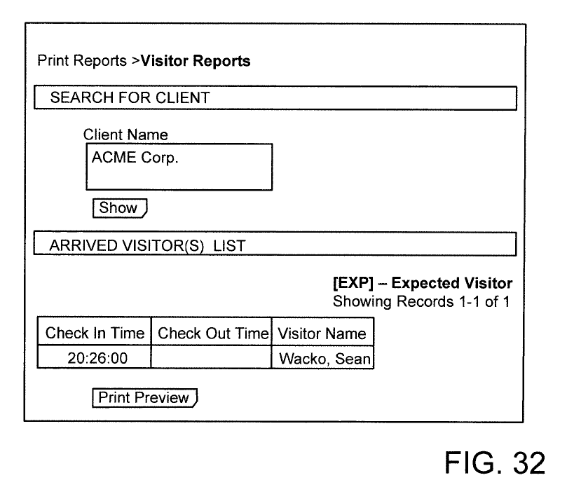

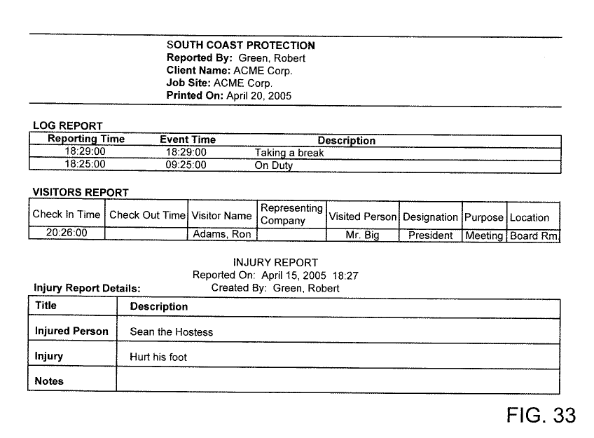

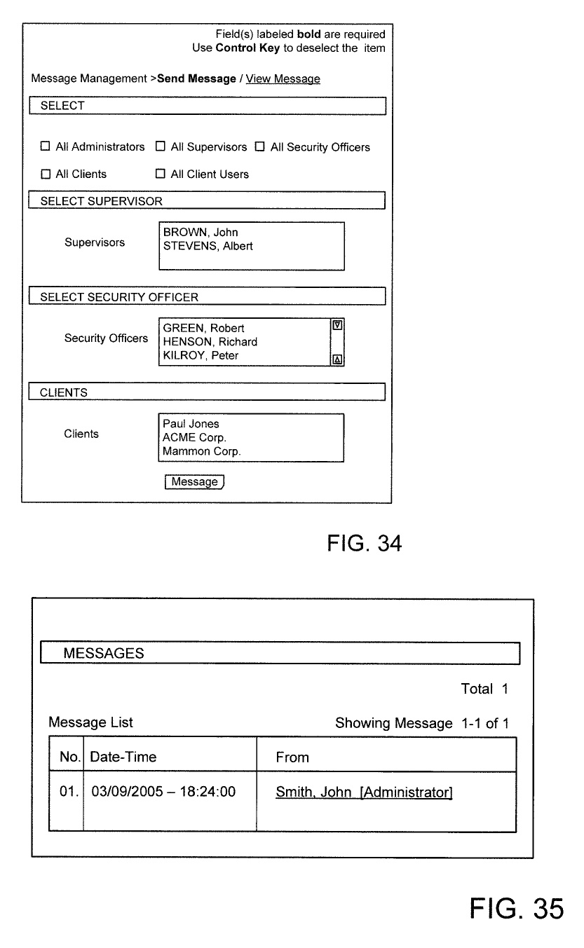

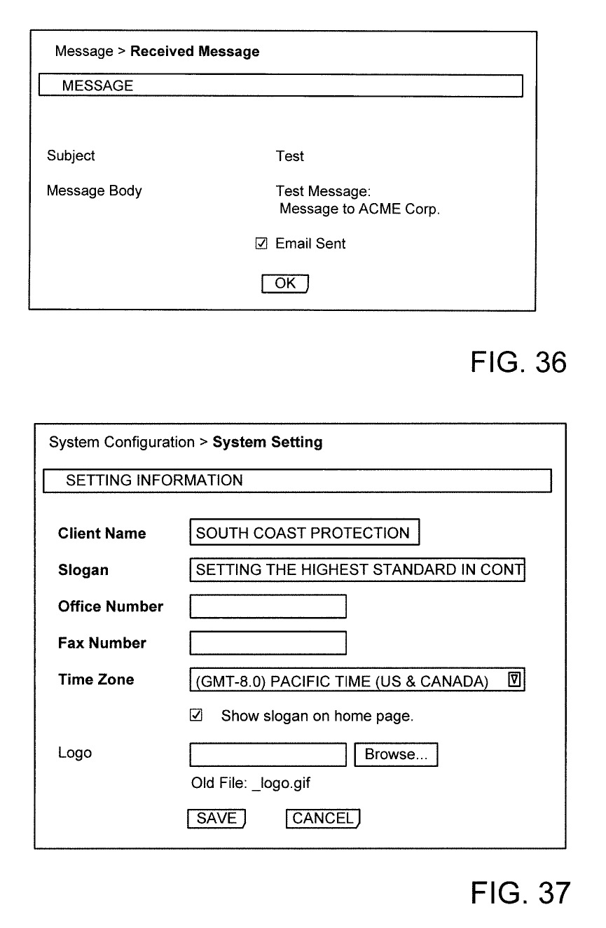

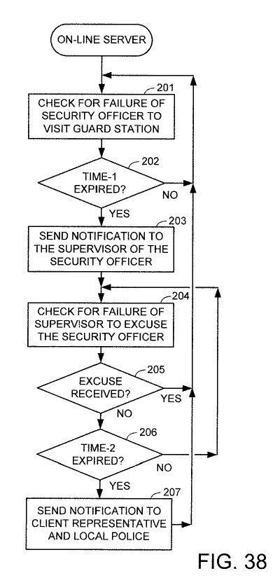

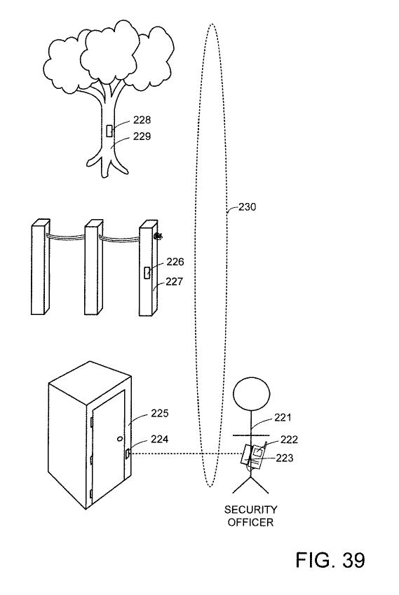

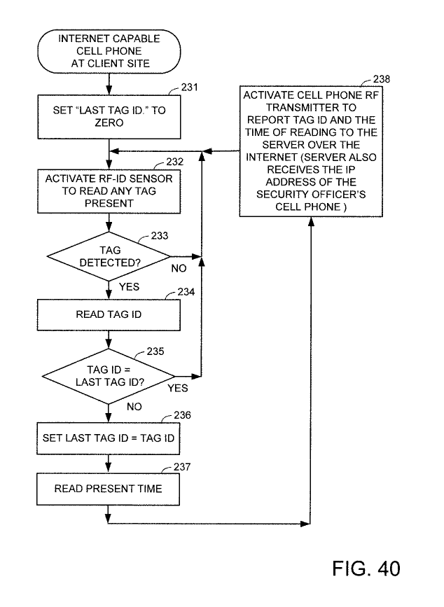

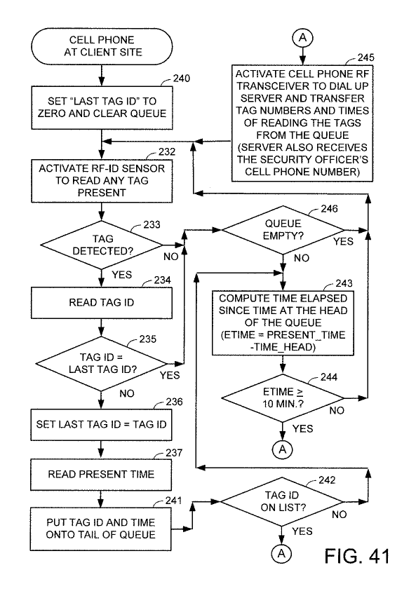

FIG. 10, for example, shows the graphical user interface responding to the administrator's selection of the “Manage User” sub-menu item. The graphical user interface responds to the selection by displaying a form 113 for the service function in the right-hand side of the display screen. The administrator can enter a user code into the form 113 to select an existing user of the on-line system, or the administrator can click on a drop-down menu to select a user type (i.e., administrator, supervisor, security officer, or client) to see and select from a list of users of the particular type.

In general, an administrator has access to all of the on-line service functions, supervisors have access to all of the on-line service functions related to management of the security officers, and security officers and clients have limited access to the service functions.

FIG. 11 shows the main and sub-menu items for an administrator. User management 121 involves management of system usernames and passwords for all on-line users, assigning supervisors and security officers to respective client sites, assigning access rights of the supervisors to various ones of the on-line service functions, and the entry and editing of a supervisor call list.

Client management 122 includes the user management of the client and assignment of access rights of the client to various on-line service functions. Client management further includes management of the client's site, access to logs for the client's site, management of a client call list for alarm conditions at the client's site, management of a service call list for services that might be needed at the client's site, management of keys for access to buildings and rooms at the client's site, and managing authorized keys to the client's employees.

Shift management 123 includes setting a shift for a security officer, editing a shift, assigning the shift to a security officer, and scheduling at a job site.

The masters function 124 is performed only by an administrator, and it involves setting up identifiers for various persons, things, or actions relating to security system management. The identifiers appear in the forms and in particular drop-down menus used in the forms. The use of such identifiers facilitates entry of and access to information in the various databases of the on-line security management system.

Training management 125 involves the management of training for the security officers.

Message management 126 involves one user of the on-line system sending a message to another user of the on-line system.

Document management 127 involves supervisors creating documents for viewing by security officers.

View log reports 128 involves viewing reports of basic security officer activities.

View Reports 129 involves viewing various kinds of reports by supervisors and security officers, including reports about a site and reports about visitors to the site.

System configuration 130 involves an administrator viewing or changing system settings that customize the menu screens for a particular security service company.

FIG. 12 shows the main and sub-menu items typically presented by the graphical user interface to a supervisor. The main menu items include user management 131, shift management 132, key management 133, document management 134, training management 135, message management 136, visitor management 137, create reports 138, view log reports 139, view call lists 140, and print reports 141.

FIG. 13 shows the main and sub-menu items typically presented by the graphical user interface to a security guard. The main menu items include shift management 151, key management 152, document management 153, message management 154, visitors management 155, create reports 156, view call lists, and print reports 158.

FIG. 14 shows the main and sub-menu items typically presented by the graphical user interface to a client. The main menu items include user management 161, key management 162, site management 163, call lists 164, visitors management 165, view log reports 166, print reports 167, and message management 168.

FIG. 15 shows a form used by the graphical user interface for input of information about a user. In this example, a user code 16 has been assigned to a new user, and the form provides fields for entry of information related to the new user, including personal information, contact information, emergency contact information, and login information.

FIG. 16 shows a form used by the graphical user interface for assigning a supervisor to a site.

FIGS. 17 and 18 show a form used by the graphical user interface when an administrator assigns rights to a supervisor. The menu of items presented to a particular supervisor is based on the particular rights assigned to the supervisor. Similar kinds of forms are used for assigning rights to security officers and clients.

FIG. 19 shows a form used by the graphical user interface for adding or editing a client call list.

FIG. 20 shows a form used by the graphical user interface for adding or editing a service call list.

FIG. 21 shows a form used by the graphical user interface for adding or editing a specification for a key.

FIG. 22 shows a form used by the graphical user interface for editing a specification for a ring of keys.

FIG. 23 shows a form used by the graphical user interface for authorizing issuance of a key to an employee.

FIG. 24 shows a form used by the graphical user interface for adding shift slots.

FIG. 25 shows a form used by the graphical user interface for assigning a shift to a user.

FIG. 26 shows a form used by the graphical user interface for displaying user details;

FIG. 27 shows a form used by the graphical user interface for displaying a site schedule.

FIG. 28 shows a form used by the graphical user interface for creating or editing identifiers for a vehicle. The identifiers include color, make, plate type, and style.

FIG. 29 shows a form used by the graphical user interface for creating or editing identifiers for an action taken. The identifiers include activity, case, employee injury, fire, towed vehicle, and trespassing.

FIG. 30 shows a form used by the graphical user interface for adding or editing a training type. The training types include rifle fire training, and short gun fire.

FIG. 31 shows a form used by the graphical user interface for viewing a log report.

FIG. 32 shows a form used by the graphical user interface for viewing or printing a visitor report

FIG. 33 shows a print-out of various kinds of reports, including a log report, a visitors report, and an injury report.

FIG. 34 shows a form used by the graphical user interface for sending a message. The form provides a way of selecting other users of the on-line system to be recipients of the message. The user can click on “view message” to create, edit, or view the message, and can click on “message” at the bottom to send the message.

FIG. 35 shows a form used by the graphical user interface for showing a list of messages. The user can click on an item in the list to view a particular message. The message is then displayed, for example, as shown in FIG. 36.

FIG. 37 shows a form used by the graphical user interface for showing a system setting. The system setting includes a client name, slogan, office telephone number, fax number, time zone for the client, and logo. This information is used to set up information that is shown at the top of the display screen in FIG. 8.

FIG. 38 shows escalation in connection with a call list. In this example, a call list for reporting a failure of a security officer to visit a check point includes the supervisor of the security officer, a client representative, and the local police in the neighborhood of the site being monitored. When there is a failure of the security officer to visit a check point, the supervisor is notified first, without immediately notifying the client representative and the local police. The supervisor is given some time to investigate and possibly excuse the security officer's failure. For example, in step 201, the on-line server checks for a failure of a security officer to visit a check point. In step 202, if the security officer has failed to visit the check point by the expiration of a first scheduled time limit (TIME-1), then execution continues to step 203. In step 203, the on-line server sends a notification of the security officer's failure to the supervisor of the security officer. In step 204, the on-line server checks for a failure of the supervisor to excuse the security officer. For example, the on-line server schedules a second time limit (TIME-2) for the supervisor to send the server a message excusing the security officer before notification of the client representative and the local police, and in step 205 the scheduled event of notifying the client representative and the local police is removed from the list of scheduled events upon receipt of such a message excusing the security officer. If the second time limit expires before such an excuse is received, then in step 206 execution continues to step 207. In step 207, a notification is sent to the client representative and the local police.

The use of escalation in connection with a call list may involve multiple levels and time limits depending primarily on the size and nature of the site being monitored. For example, a security detail at an industrial site could involve multiple levels of supervision over security guards. In such a case, the failure of a security officer to visit a check point could involve a call to the security officer's cell phone, followed by a call to the security officer's supervisor in five minutes if the check point still has not been visited by then, followed by a call to the head of the security detail in ten minutes if the supervisor has not excused the security officer by then, followed by a call to the client representative in ten minutes if the head of the security detail has not excused the supervisor and the security officer. The escalation process could be accelerated if other abnormal conditions are detected at the site. For example, at a site monitored simultaneously by a number of security officers, the escalation process would be accelerated if another one of the security officers would fail to visit a check point at a scheduled time.

As shown in FIG. 1, a client site security system computer is coupled via the Internet to the on-line security management server 21. In this case a high-speed Internet connection provides faster and more reliable communication than a dial-up telephone modem. Many client sites to be monitored, however, do not have a high-speed Internet connection. In these situations, a client site computer will use a dial-up telephone modem or cell phone for communication with the on-line security management server 21.

Some client sites do not have an installed security system computer. In this case, it is possible to program a security officer's cell phone to function as a security system computer. As shown in FIG. 39, for example, the site to be monitored is a construction site. A security officer 221 has an Internet capable cell phone 222 coupled to an RF-ID tag reader 223. RF-ID tags are used to designate check points at the construction site. For example, an RF-ID tag 224 is placed next to a door 225 at the construction site, an RF-ID tag 226 is placed on a fence post 227 at the construction site, and an RF-ID tag 228 is placed on the trunk of a tree 229 at the construction site. Each RF-ID tag is programmed with a unique tag ID that can be read automatically by the tag reader 223 when the security officer 221 is close to the tag.

When the security officer 221 walks his or her round 230, the tag reader 223 detects each tag and sends the respective tag ID to the cell pone 222. Each time that the cell phone receives a tag ID that is different from the last read tag ID, the cell phone reports the new tag ID. The on-line security management server also receives the IP address of the security officer's cell phone 222, and records the time that the tag was read. The cell phone could report the actual time that the tag was read, or the server could estimate the time that the tag was read from the time of receipt of the report from the cell phone 222. In this fashion, the on-line security management server receives a report from the cell pone that a particular security officer has visited a particular check point at a particular time. The server can check for the absence of vitiation of a check point in a specified sequence, or a failure to visit a particular check point by a scheduled time. The server can notify selected parties of missed rounds, late rounds, or any other pre-configured alarm settings.

The RF-ID tag reader 223 can be built into a sleeve or case of the Internet capable cell phone 222. For example, the cell phone is a Nokia 5140 cell phone and the RF-ID tag reader is part of a case that receives the Nokia 5140 cell phone. Such a cell phone having a built-in RF-ID tag reader is supplied by Avnet, Inc., 2211 South 47th Street, Phoenix, Ariz. 85034. The RF-ID tag reader will read the tag when the tag reader touches the tag.

The sensitivity of the tag reader can be set to read the tag when the tag reader is placed within a certain number of inches of the tag. In practice, it is desirable for the tags to be placed at a height of about five feet above the ground, and for the tag reader to be set to read a tag only when the tag reader is closer than about twelve inches from the tag. In this fashion, a security office can walk past a tag and the tag will be read and reported to the on-line server only when the security officer intentionally raises the tag reader and cell phone off his or her belt and places the tag reader up close to the tag. This permits the tag reader and cell phone to be turned on whenever the security officer is at a site without sending a confusing report when the security officer enters or leaves the site during a shift change.

The security officer can also use the cell phone 222 to send voice clips and text messages to the on-line server. The cell phone 222 may also have a built-in camera that can be used to send pictures or short movies of the site to the on-line server. The voice clips, text messages, pictures, and movies, could be combined with additional information read from the tags, such as a name or street address of the site. These data can be stored in a database in the server for viewing, edited, and copying by the security guard or a supervisor when needed for creating reports related to activities or incidents at the site.

FIG. 40 shows programming of a security officer's Internet capable cell phone so that the cell phone will function as a client site security system computer. In a first step 231, the processor in the cell phone sets a variable called “last tag ID” to zero. Then in step 232, the cell phone activates the RF-ID tag sensor to read any tag present. In step 233, if a tag is detected, then execution continues to step 234. Otherwise, execution loops back to step 232 to activate the RF-ID tag sensor on a periodic basis until a tag is detected.

In step 234, the cell phone reads the tag ID from the tag reader. In step 235, the processor in the cell pone compares the tag ID read from the tag reader to the tag ID stored in the variable “last tag ID”. If the tag ID read from the tag reader is the same as the tag ID stored in the variable “last tag ID”, then execution loops back to step 232 to periodically activate the RF-ID tag sensor. Once the tag ID read from the tag reader is different from the tag ID stored in the variable “last tag ID”, execution continues from step 235 to step 236. In step 236, the processor in the cell phone sets the variable “last tag ID” equal to the tag ID just read from the tag reader. In step 237, the processor in the cell phone reads the present time from its internal clock. In step 238, the cell phone computer activates the cell phone RF transmitter to report the tag ID and the time of reading the tag (from step 237) over the Internet to the on-line security management server. The on-line security management server also receives the security officer's IP address.

It is preferred to use an Internet capable cell phone for communication between the tag reader and the on-line server. This permits short digital messages to be sent quickly between the cell pone and the on-line server, without the delay of dialing-up the server. It is possible, however, to use a cell phone that dials-up the server, for example, if there would be a temporary loss of Internet service. In this case, the cell phone could dial-up the on-line server each time that a tag is read, but the use of a rather large number of tags at a site would cause the cell phone to make frequent calls to the server. The frequency of calls to the server could be reduced by the cell phone queuing tag IDs and tag reading times as the tags are detected, and calling the server to report the content of the queue at a limited frequency or when the security officer visits particular check points designated by particular tag IDs. This is demonstrated by the program shown in FIG. 41.

In a first step 240, the variable “last tag ID” is set to zero, and also a queue is cleared. The following steps 231 to 237 in FIG. 41 are the same steps 231 to 237 used in FIG. 40. Then in a step 241, the tag ID and present time (read in step 237) are put onto the tail of a queue. In step 242, the tag ID is compared to a list of tag IDs that should be immediately reported to the server. Alternatively, in step 242, the tag ID could be compared to a certain range of tag IDs, or otherwise decoded (for example by comparison to a pre-determined bit mask) to determine if the tag ID should be immediately reported to the server.

If the tag ID is not to be immediately reported to the server, then execution continues from step 242 to step 243. In step 243, the time elapsed since the time in the entry at the head of the queue is computed, for example, by subtracting the time in the entry at the head of the queue from the present time provided by the cell phone's clock. In step 244, if the elapsed time is not greater than or equal to ten minutes, then execution loops from step 244 back to step 232. If the elapsed time is greater than or equal to 10 minutes, then execution continues to step 245 to activate the cell phone RF transceiver to dial up the server and to transfer the tag IDs and times of reading the tags from the queue. The server also receives the security officer's cell phone number. In this fashion, the content of the queue is dumped to the server with a delay in reporting the tag ID that is no more than about 10 minutes plus the time to make the cell pone call to the server. After step 245, execution continues to step 232.

In step 242, if the tag ID should be immediately reported to the server because the tag ID is on the list, then execution branches from step 242 to step 245 in order to dump the queue to the on-line server.

In view of the above, there has been described an on-line security management system using the Internet for communication between a server and security officers, supervisors, client representatives, and a security system computer at a client site. On-line access to the server provides integration and management of security system functions such as maintenance of call lists and reports, shift management, and supervision of security officers. The use of the Internet for communication between the server and the client site computer not only provides faster and more reliable communication but also enables the client site computer to request the server to schedule a contingent future event including a need to service a call list unless the client site computer reports a condition warranting the removal of the contingent event from the schedule. For example, the failure of a security officer to visit a check point at a scheduled time results in the server accessing a call list to notify a designated recipient.

What is claimed is:

1. A security management system comprising a server on the Internet, the server being programmed for maintaining a database including a call list for a site in response to user access over the Internet, the server being programmed for accessing the call list in order to send a notification of an abnormal condition at the site to a recipient on the call list.

2. The system as claimed in claim 1, wherein the server is programmed for receiving a report of the alarm condition at the site, the report of the alarm condition being transmitted over the Internet from the site to the server.

3. The system as claimed in claim 1, wherein the server is programmed for receiving a message of a normal condition at the site, the message being transmitted over the Internet from the site to the server, and wherein the server is programmed for accessing the call list upon failing to receive the message from the site.

4. The system as claimed in claim 3, wherein the message indicates that a security officer has visited a check point at the site.

5. The system as claimed in claim 3, wherein the message is periodically sent from the site to the server to provide an indication of data transmission capability from the site to the server.

6. The system as claimed in claim 1, wherein the server is programmed for scheduling future contingent events, and for removing an indication of an event from a list of scheduled events in response to receipt of a message from the site regarding the event.

7. The system as claimed in claim 1, wherein the call list specifies a notification method for the recipient, and the server is programmed for using the notification method specified for the recipient for notifying the recipient.

8. The system as claimed in claim 7, wherein the server is programmed for detecting a failure of the recipient to be notified using the notification method specified for the recipient, and for using an alternative notification method upon detecting the failure of the recipient to be notified using the notification method specified for the recipient.

9. The system as claimed in claim 1, wherein the server is programmed to provide the user access over the Internet when the user executes an Internet browser program.

10. The system as claimed in claim 1, wherein the server is programmed to provide on-line access over the Internet to four classes of users, including an administrator class, a supervisor class, a security officer class, and a client class, and wherein the server is programmed to provide a different set of user service functions to each of the four classes of users.

11. The system as claimed in claim 1, wherein the user access over the Internet further includes scheduling security officer shifts at the site, managing use of keys at the site, and managing access of visitors to the site.

12. The system as claimed in claim 1, wherein the user access over the Internet further includes user access over the Internet to reports of activity at the site.

13. A security management system comprising a server on the Internet;
the server being programmed for maintaining data about security officers, supervisors of the security officers, and clients having sites to be monitored;
the server being programmed for access by operation of an Internet browser program by the security officers, supervisors of the security officers, and representatives of the clients;
the server being programmed for setting up respective call lists of recipients and methods for notifying the recipients of abnormal conditions at the sites, and for scheduling security officer shifts at the respective sites, managing use of keys at the respective sites, and managing access of visitors to the respective sites.

14. The system as claimed in claim 13, wherein the server is programmed to receive over the Internet a report of an alarm condition from a site, and to respond to the report of the alarm condition from the site by accessing a call list for the site to notify a recipient on the call list of the alarm condition.

15. The system as claimed in claim 13, wherein the server is programmed to schedule a time for receipt of a message from a site, and to respond to a failure to receive a message from the site at the scheduled time by accessing a call list for the site to notify a recipient on the call list of the failure to receive a message from the site at the scheduled time.

16. The system as claimed in claim 13, wherein the server provides access over the Internet to reports of activity at the sites including log reports of security officer activity, visitor reports, and incident reports.

17. A method of managing security at a site, the site including a security system computer linked via the Internet to a server, the server being accessible over the Internet by a user operating an Internet browser program, said method comprising:
the user accessing the server using the Internet browser program to set up a call list for the site, the security system computer sending messages over the Internet to the server to report normal conditions at the site to the server at scheduled times, and upon failing to receive a message reporting a normal condition at the site at a scheduled time, the server accessing the call list in order to send a notification to a recipient on the call list.

18. The method as claimed in claim 17, wherein at least some of the messages report a security officer visiting check points at the site.

19. The method as claimed in claim 17, wherein at least some of the messages are sent periodically from the site computer to the server to indicate data transmission capability.

20. The method as claimed in claim 17, which includes the server scheduling future contingent events, and the server removing indications of at least some of the future contingent events from a list of scheduled events in response to receipt of at least some of the messages from the site.

21. The method as claimed in claim 17, which includes the user accessing the server over the Internet using the Internet browser program to schedule security officer shifts at the site, manage use of keys at the site, and manage access of visitors to the site.

22. A computer-implemented method of managing security at a site, the method comprising:
scheduling a security officer to visit check points at the site;
setting up a call list including at least one recipient to be notified in the event of the security officer failing to visit at least one of the check points at a scheduled time; and
upon detecting a failure of the security officer to visit said at least one of the check points at the scheduled time, accessing the call list to notify said at least one recipient.

23. The method of claim 22, wherein the call list specifies a particular method for notifying said at least one recipient, and the particular method is used for notifying said at least one recipient of the failure of the security officer to visit said at least one of the check points at the scheduled time.

24. The method as claimed in claim 22, wherein the call list is set up by an Internet server in response to a user operating an Internet browser program to access the server.

25. The method as claimed in claim 22, wherein the call list specifies at least a first recipient and a second recipient, and the method includes sending a first notification to the first recipient, and then sending a second notification to the second recipient upon failing to receive an acknowledgement from the first recipient after a certain period of time.

26. A computer-implemented method of managing security at a site, the method comprising:
scheduling a security officer to visit the site;
setting up a call list including at least one recipient to be notified upon detecting a failure of the security officer to follow a designated path at the site; and
upon detecting a failure of the security officer to follow the designated path at the site, accessing the call list to notify said at least one recipient.

27. The method of claim 26, wherein the call list specifies a particular method for notifying said at least one recipient, and the particular method is used for notifying said at least one recipient of the failure of the security officer to follow the designated path at the site.

28. The method as claimed in claim 26, wherein the call list is set up by an Internet server in response to a user operating an Internet browser program to access the server.

29. The method as claimed in claim 26, wherein the call list specifies at least a first recipient and a second recipient, and the method includes sending a first notification to the first recipient, and then sending a second notification to the second recipient upon failing to receive an acknowledgement from the first recipient after a certain period of time.
